(19) United States
(12) Patent Application Publication
(10) Pub. No.: US 2019/0293267 A1
(43) Pub. Date: Sep. 26, 2019

(54) LED HIGH BAY LUMINAIRE

(71) Applicant: Amled Technologies, Inc., Itasca, IL (US)

(72) Inventor: Madan Marshal, Itasca, IL (US)

(21) Appl. No.: 15/926,128

(22) Filed: Mar. 20, 2018

(51) Int. Cl. F21V 17/14; F21V 23/04

(52) U.S. Cl. CPC F21V 17/14; F21V 23/06; F21V 23/0464; F21V 23/0471

(57) ABSTRACT

Presently provided is an LED luminaire having a lighting panel with an array of LEDs. A centrally oriented opening is in the lighting panel. The LED luminaire is configured for the installation of at least one sensor in the centrally oriented opening in the lighting panel. A method of tool-lessly installing at least one sensor with a luminaire is provided. An electrical connector is provided, the electrical connector has a first cable configured to be electrically connected with electrical lead lines, a second cable configured to be electrically connected with a lighting panel or driver, and a third cable configured to be electrically connected with a sensor. The electrical connector is configured to provide electrical communication with the lighting panel and sensor.

### FIELD OF THE DISCLOSURE

The present invention relates to electric lighting fixtures and particularly luminaires such as high bay luminaires. More particularly, the present invention relates to an LED high bay luminaire configured for installation of a sensor.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Recently, light emitting diode (LED) lamps have become widely used in a variety of applications. An LED lamp is a solid-state lamp that uses LEDs as the source of light. An LED may comprise a conventional semiconductor light emitting diode or an organic or polymeric light emitting diode. LED lamps may have one or more advantages over prior lamp technologies, for example, LED lamps do not contain mercury, they may turn on more instantaneously, they may have a longer service life, and they may have a greater efficiency than the prior lamp technologies.

High bay luminaires are designed to be used in very high areas, approximately 8 m and higher, to provide well distributed and uniform light for open areas. High bay luminaires typically have optics for providing a desired light output. It may be desired to provide a sensor, such as a light or motion sensor, for operation of a high bay luminaire.

### SUMMARY

In one aspect of the present disclosure, an LED luminaire comprises a lighting panel having an array of LEDs. A centrally oriented opening is in the lighting panel. The LED luminaire is configured for the installation of at least one sensor in the centrally oriented opening in the lighting panel.

In another aspect of the present disclosure, an electrical connector is provided for electrically connecting a lighting panel and at least one sensor. The electrical connector comprises a first cable configured to be electrically connected with electrical lead lines, a second cable configured to be electrically connected with a lighting panel, and a third cable configured to be electrically connected with a sensor.

In a further aspect of the present disclosure, a method of tool-lessly installing at least one sensor in a luminaire is provided. The method comprises providing a luminaire having a lighting panel with an array of LEDs disposed about a centrally oriented opening in the lighting panel; providing a sensor housing having the at least one sensor therein; electrically connecting the at least one sensor with the luminaire; inserting the sensor housing into the centrally oriented opening; and removably locking the sensor housing in the centrally oriented opening in the lighting panel.

### BRIEF DESCRIPTIONS OF THE DRAWINGS

The following figures, which are idealized, are not to scale and are intended to be merely illustrative of aspects of the present disclosure and non-limiting. In the drawings, like elements are depicted by like reference numerals. The drawings are briefly described as follows.

FIG. 1 is a perspective view of an illustrative example of the LED high bay luminaire of the present disclosure;

FIG. 2 is a perspective view of the LED high bay luminaire shown in FIG. 1 showing a sensor removed therefrom;

FIG. 3 is an exploded view of the LED high bay luminaire shown in FIG. 1 showing component parts thereof;

FIG. 4 shows a perspective view of an example of a sensor housing configured to fit with the LED high bay luminaire shown in FIG. 1;

FIG. 5 shows a perspective view of an example locking ring configured to tool-lessly fasten and unfasten the sensor housing shown in FIG. 4 with the LED high bay luminaire shown in FIG. 1;

FIG. 6 shows a perspective view of a central portion of the LED high bay luminaire shown in FIG. 1 configured to receive the sensor housing shown in FIG. 4;

FIG. 7 shows a perspective view of a cover; and

FIG. 8 shows an illustrative view of a connector that may be used with the LED high bay luminaire shown in FIG. 1.

### DETAILED DESCRIPTION

The present disclosure provides a luminaire, such as high bay luminaires, having an array of LEDs. The luminaire is configured for installation of a sensor central with the array of LEDs. A method of installing a sensor central with an array of LEDs and a connector are also presently disclosed.

Reference will now be made in detail to the present exemplary embodiments and aspects of the present invention, examples of which are illustrated in the accompanying figures. The same reference numbers may be used in the figures to refer to the same or like parts. The presently disclosed embodiments, aspects, and features of the present invention are not to limit the presently claimed invention as other and different embodiments, aspects, and features will become apparent to one skilled in the art upon reading the present disclosure.

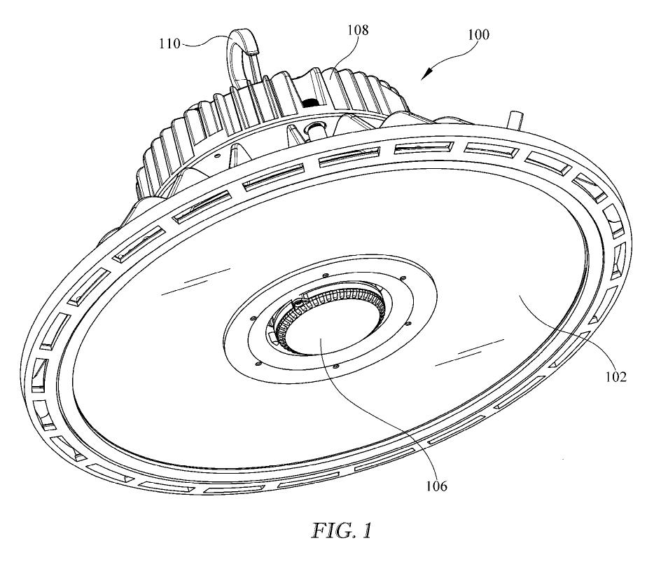

FIGS. 1-3 show perspective views and an exploded view of LED high bay luminaire 100. LED luminaire 100 has a lighting panel 102 having an array of LEDs about an opening 103. Opening 103 is centrally oriented in the lighting panel 102 and configures LED luminaire 100 for the installation of at least one sensor. Sensor housing 106 may hold or house one or more sensors. The sensor(s) housed in sensor housing 106 may be configured to switch the array of LEDs, on lighting panel 102, on and off.

Sensor housing 106 may be configured to be tool-lessly installed in centrally oriented opening 103, in the lighting panel 102. For example, luminaire 100 and sensor housing 106 may comprise a twist-and-lock configuration or feature. Sensor housing 106 may house at least one of a motion sensor and a light sensor.

Lighting panel 102 may be circular or have a disk shaped configuration. Centrally oriented opening 103, in lighting panel 102, may be circular and the sensor housing 106 may be circular. For example, centrally oriented opening 103 may be configured to receive sensor housing 106 and for the rotation or twisting of sensor housing 106 in centrally opening 103. Sensor housing 106 may be configured to be rotated and removably locked into centrally oriented opening 103 in the array of LEDs or lighting panel 102.

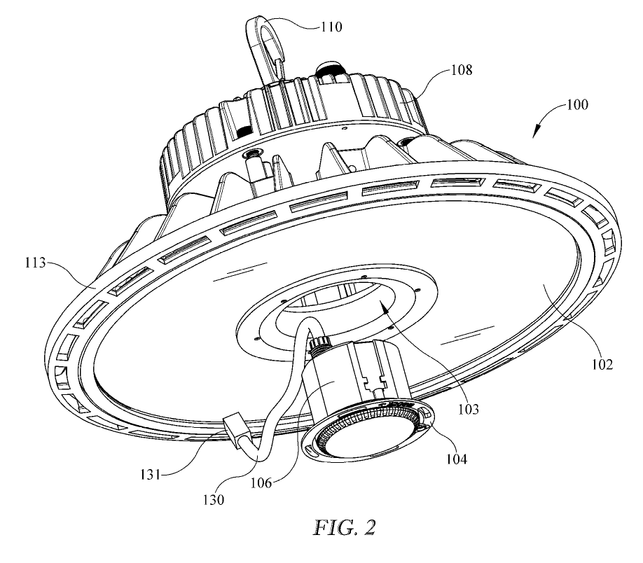

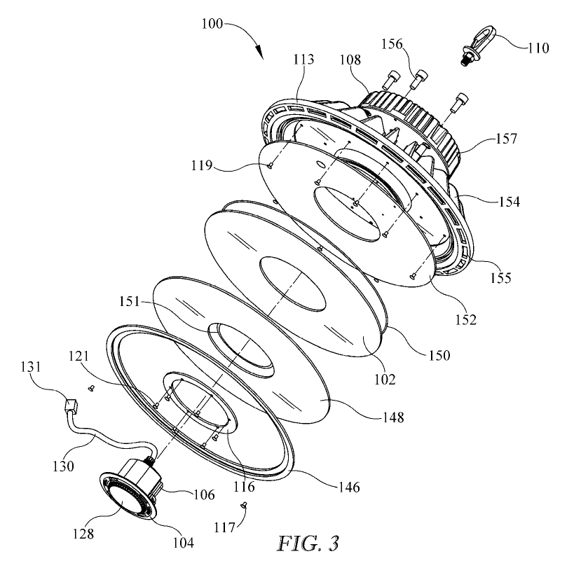

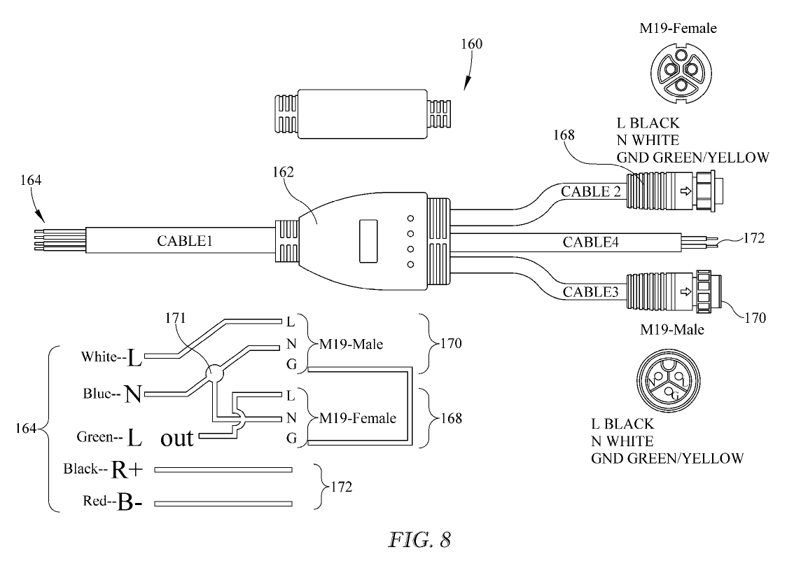

FIG. 3 is an exploded view of LED high bay luminaire 100, showing component parts thereof. LED luminaire 100 may have lighting panel 102 with opening 103, centrally oriented therein, as shown in FIGS. 1 and 2. Sensor housing 106 may have bottom wall 128 which may be configured for hand gripping or rotation. Electrical line 130 may extend from sensor housing 106 which may be configured for electrical communication with electrical lines external of luminaire 100, luminaire 100, lighting panel 102, or other electrical communication(s). For example, electrical plug or receptacle 131 may extend from electrical line 130 which may be configured to fit with an electrical connector, such as electrical connector 160 shown in FIG. 8, a driver in luminaire 100, or other electrical line.

Luminaire 100 may have a lens 148 configured to cover LED board 152. In at least one embodiment, lens 148 is configured be held to luminaire 100 with outer trim ring 146 and fasteners 117. Inner trim ring 116 may also, or alternatively, be used to hold lens 148 to luminaire 100 with fasteners 121. Inner gasket 151 may be positioned to seal an inner edge of lens 148 with luminaire 100 and outer gasket 150 may be positioned to seal an outer edge of lens 148 with luminaire 100.

LED board 152 may have an array of LEDs disposed thereon and may be in the configuration of lighting panel 102. In at least one embodiment of the present disclosure, lighting panel 102 comprises LED board 152 and an array of LEDs disposed on LED board 152. LED board 152 may be held to luminaire 100 with fasteners 119. Luminaire housing 113 may be configured to receive or hold sensor housing 106, lens 148, and LED board 152. Luminaire housing 113 may have a heat sink for dissipating heat generated with the activation of the array of LEDs on lighting panel 102. For example, luminaire housing 113 may have apertures 155 proximate an outer perimeter or fins 154.

A driver cover 108 may be configured to house a driver for activating the array of LEDs. Driver cover 108 may have an outer heat transferring surface, for example fins 157. Driver cover may be configured to be held onto luminaire housing 113 with fasteners 156. A mount 110 may extend from driver cover 108 and may be configured for mounting or hanging luminaire 100.

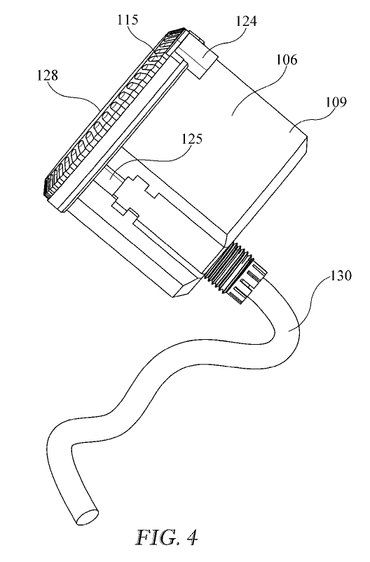

FIG. 4 shows a perspective view of sensor housing 106 configured to fit with LED high bay luminaire 100. Sensor housing 106 may have a circular sidewall 109 and configured to fit into opening 103 in lighting panel 102. For example, sensor housing 106 may be configured for tool-less installation and removal from luminaire 100 with a twist-and-lock mechanism. Sensor housing 106 may have a bottom wall 128 configured for sensing therethrough with at least one sensor housed therein. Sensor housing 106 may have a gripping surface 115 which may configure sensor housing for hand rotation or twist-and-lock installation. For example, gripping surface 115 may extend below lens 148 and have ribs or other features for rotating sensor housing 106 upon being placed into opening 103 in light panel 102. Sensor housing 106 may have a fastener receptacle 124 extending outwardly from sensor housing sidewall 109. Fastener receptacle 124 may be configured and disposed for fastening sensor housing 106 with luminaire 100. Sensor housing 106 may have a fastener receptacles 125 extending outwardly from sensor housing sidewall 109. Fastener receptacles 125 may be configured and disposed for fastening sensor housing 106 with locking ring 104.

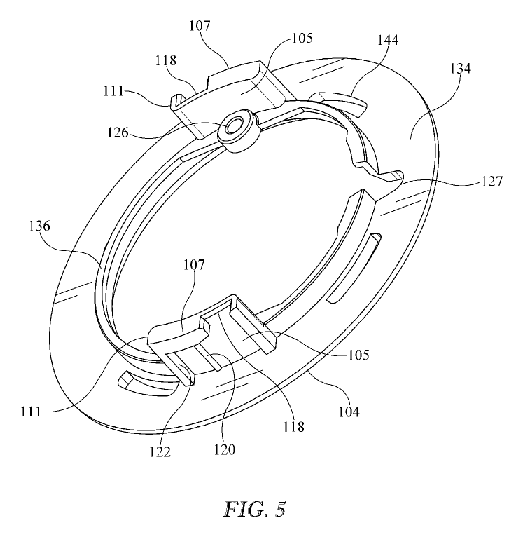

FIG. 5 shows a perspective view of an example locking ring 104 configured to tool-lessly fasten and unfasten sensor housing 106 with the LED high bay luminaire 100. Locking ring 104 may be configured to be fastened with sensor housing 106. For example, fastener receivers 126 may align with fastener receptacles 125 for fastening locking ring 104 with sensor housing 106.

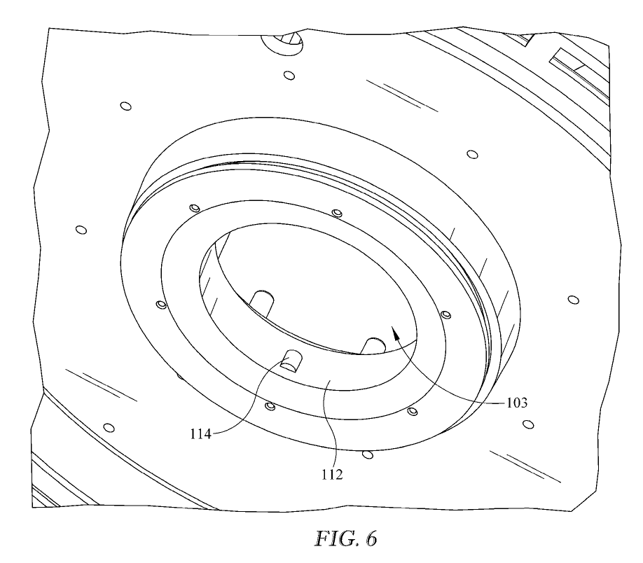

Locking ring 104 may have a twist-and-lock configuration. For example, lock 111 may have lock side wall 105 extending from flange 134. Sidewall 105 may have an upper wall 107 configured to cooperate with a protuberance 114 in opening 103, shown in FIG. 6. For example, upper wall 107 may have an opening or receiver 118 configured to receive protuberance 114. Bump out 120 may be configured to cooperate with protuberance 114 upon being received in receiver 118 and rotated. For example, bump out 120 may provide a resistance to an unlocking rotation of sensor housing 106 in opening 103. Locking ring 104 and sensor housing 106 may be twisted or rotated in opening 103 until protuberance 114 meets stop 122.

Locking ring 104 may have an inner wall 136 configured to extend into opening 103. Flange 134 may have a recess 127 configured and disposed to align with fastener receptacle 124 for fastening sensor housing 106 with luminaire 100. Flange 134 may have one or more openings 144 for air flow as may be desired.

FIG. 6 shows a perspective view of a central portion of the LED high bay luminaire 100 configured to receive the sensor housing 106. Central opening 103 is defined with inner sidewall 112. Extending inward from inner sidewall 112 is protuberance 114. A protuberance 114 may extend in from each side, or each 180° position, of sidewall 112. Protuberances 114 may be configured and disposed to cooperate with locks 111 on locking ring 104. Protuberances 114 may have a rounded outer surface for cooperating with bump out 120 in sidewall 105 of lock 111. For example, a twist or rotation of sensor housing 106 may cause bump out 120 to cooperate with, or interfere with, protuberance 114 and removably hold sensor housing 106 in locked configuration. Protuberance 114 may cooperate with upper wall 107 of lock 111 to hold sensor housing 106 in luminaire 100. Protuberance 114 may be configured to stop a rotation of sensor housing 106 in opening 103 by cooperating with stop 122.

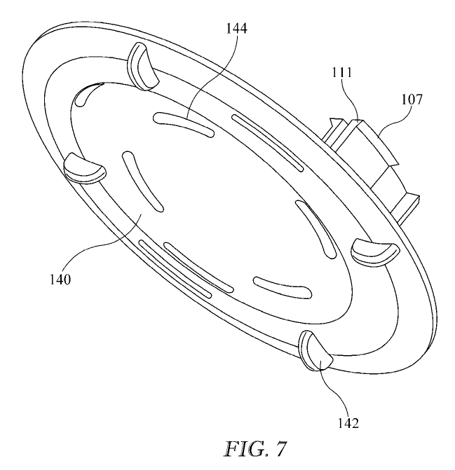

FIG. 7 shows a perspective view of cover 140. Cover 140 may be installed in luminaire 100 when it is desired not to have a sensor installed into opening 103 of luminaire 100. Cover 140 may have a twist-and-lock feature, or lock 111. Cover 140 may be configured to cover opening 103 instead of sensor housing 106. Cover 140 may have extensions 142 for rotating cover 140 about opening 103 and locking locks 111 with protuberances 114.

FIG. 8 shows an illustrative view of an electrical connector 160 that may be used with the LED high bay luminaire of the present disclosure. Electrical connector 160 has body 162 and cables extending from each end. For example, cable 1, 164, may be configured to be electrically connected with electrical lines external of luminaire 100, for example power supply or control lines. Body 162 may be configured for splitting or routing lines 164 to selected plugs or adapters or for communicating lines from plugs or cables. For example, cable 2, or plug or adapter 168, may be configured to electrically connect with lighting panel 102. Cable 3, or plug or adapter 170, may be configured to electrically connect with at least one sensor in sensor housing 106. For example, plug or adapter 170 may be configured to plug into electrical plug or receptacle 131, shown in FIG. 2. Electrical connector 160 may also have cable 4, or lines 172, configured for controlling dimming of luminaire 100. In at least one embodiment, electrical connector 160 is configured to electrically communicate at least one sensor with lighting panel 102 or a driver, in driver cover 108. For example, node 171 may provide an electrical communication between at least one sensor in sensor housing 106 and lighting panel 102 or a driver, in driver cover 108.

In at least one embodiment of the present disclosure, LED luminaire 100 comprises electrical connector 160 having a first cable 164 configured to be electrically connected with electrical lead lines external of luminaire 100, a second cable 168 configured to be electrically connected with lighting panel 102, and a third cable 170 configured to be electrically connected with at least one sensor in sensor housing 106. Electrical connector 160 may further comprise a fourth cable 172 configured for dimming the array of LEDs on lighting panel 102.

A method of tool-lessly installing at least one sensor in a luminaire is presently disclosed. The method comprises providing a luminaire having a lighting panel with an array of LEDs disposed about a centrally oriented opening in the lighting panel. Providing a sensor housing having the at least one sensor therein. Electrically connecting the at least one sensor with the luminaire and inserting the sensor housing into the centrally oriented opening. The sensor housing may then be removably locked in the centrally oriented opening in the lighting panel. The sensor housing may be removably locked in the centrally oriented opening by hand rotating the sensor housing in the centrally oriented opening which may be circular. A rotation of the sensor housing in the central open may cause an upper wall of a lock on the sensor housing to cooperate with a protuberance in the centrally oriented opening, thereby holding the at least one sensor in the luminaire. For example, a bump out may extend outward from a sidewall of the lock and cooperate with the protuberance, thereby removably locking the sensor housing in the luminaire.

Electrically connecting the at least one sensor with the luminaire may be performed tool-lessly, for example electrical connector 160 may be used for electrically connecting the at least one sensor with the luminaire. In at least one embodiment, electrically connecting the at least one sensor with the luminaire comprises plugging in a first plug for energizing the array of LEDs and plugging in a second plug for electrically cooperating the sensor with the array of LEDs.

The invention is illustrated by way of example in the drawing figures and throughout the written description. It should be understood that numerous variations of the presently disclosed high bay luminaire are possible, for example, variations of the housing and the lock and other such variations are a part of the presently claimed high bay luminaire.

One feature or aspect of an embodiment is believed at the time of the filing of this patent application to possibly reside broadly in an LED luminaire comprising: a lighting panel having an array of LEDs; a centrally oriented opening in the lighting panel; and wherein the LED luminaire is configured for the installation of at least one sensor in the centrally oriented opening in the array of LEDs.

Another feature or aspect of an embodiment is believed at the time of the filing of this patent application to possibly reside broadly in an LED luminaire comprising a sensor housing configured to be installed in the centrally oriented opening in the array of LEDs, the sensor housing holds the at least one sensor.

Yet another feature or aspect of an embodiment is believed at the time of the filing of this patent application to possibly reside broadly in an LED luminaire, wherein the at least one sensor is configured to switch the array of LEDs on and off.

Still another feature or aspect of an embodiment is believed at the time of the filing of this patent application to possibly reside broadly in an LED luminaire wherein the sensor housing is configured to be tool-lessly installed in the centrally oriented opening in the lighting panel.

A further feature or aspect of an embodiment is believed at the time of the filing of this patent application to possibly reside broadly in an LED luminaire, wherein the at least one sensor has at least one of a motion sensor and a light sensor.

Another feature or aspect of an embodiment is believed at the time of the filing of this patent application to possibly reside broadly in an LED luminaire, wherein the lighting panel is circular.

Yet another feature or aspect of an embodiment is believed at the time of the filing of this patent application to possibly reside broadly in an LED luminaire, wherein the centrally oriented opening in the lighting panel and the sensor housing are circular.

Still another feature or aspect of an embodiment is believed at the time of the filing of this patent application to possibly reside broadly an LED luminaire, wherein the sensor housing is configured to be rotated and removably locked into the centrally oriented opening in the array of LEDs.

A further feature or aspect of an embodiment is believed at the time of the filing of this patent application to possibly reside broadly in an LED luminaire, wherein the sensor housing comprises a locking ring configured to cooperate with a protuberance extending into the centrally oriented opening in the lighting panel.

Another feature or aspect of an embodiment is believed at the time of the filing of this patent application to possibly reside broadly in an LED luminaire, wherein the sensor housing has a hand gripping surface, configuring the sensor housing to be rotated by hand and to be tool-lessly installed in the LED luminaire.

Yet another feature or aspect of an embodiment is believed at the time of the filing of this patent application to possibly reside broadly in an LED luminaire further comprising an electrical connector, the electrical connector having a first cable configured to be electrically connected with electrical lead lines external of the luminaire, a second cable configured to be electrically connected with the lighting panel, and a third cable configured to be electrically connected with the at least one sensor

One feature or aspect of an embodiment is believed at the time of the filing of this patent application to possibly reside broadly in an LED luminaire, wherein the second cable and the third cable each terminate with plug.

Another feature or aspect of an embodiment is believed at the time of the filing of this patent application to possibly reside broadly in an LED luminaire, wherein the electrical connector further comprises a fourth cable configured for dimming the array of LEDs.

Yet another feature or aspect of an embodiment is believed at the time of the filing of this patent application to possibly reside broadly an electrical connector comprising a first cable configured to be electrically connected with electrical lead lines, a second cable configured to be electrically connected with a lighting panel, and a third cable configured to be electrically connected with a sensor.

Still another feature or aspect of an embodiment is believed at the time of the filing of this patent application to possibly reside broadly in a method of tool-lessly installing at least one sensor in a luminaire comprising the steps of: providing a luminaire having a lighting panel with an array of LEDs disposed about a centrally oriented opening in the lighting panel; providing a sensor housing having the at least one sensor therein; electrically connecting the at least one sensor with the luminaire; inserting the sensor housing into the centrally oriented opening; and removably locking the sensor housing in the centrally oriented opening in the lighting panel.

A further feature or aspect of an embodiment is believed at the time of the filing of this patent application to possibly reside broadly in a method of installing at least one sensor in a luminaire, wherein the step of removably locking the sensor housing in the centrally oriented opening in the lighting panel comprises hand rotating the sensor housing in the centrally oriented circular opening.

Another feature or aspect of an embodiment is believed at the time of the filing of this patent application to possibly reside broadly in a method of installing at least one sensor in a luminaire, wherein the step of rotating the sensor housing in the centrally oriented opening comprises cooperating an upper wall of a lock on the sensor housing with a protuberance in the centrally oriented opening, thereby holding the at least one sensor in the luminaire.

Yet another feature or aspect of an embodiment is believed at the time of the filing of this patent application to possibly reside broadly in a method of installing at least one sensor in a luminaire, wherein the step rotating the sensor housing in the centrally oriented circular opening comprises cooperating a bump out extending outward from a sidewall of the lock with the protuberance, thereby removably locking the sensor housing in the luminaire.

Yet a further feature or aspect of an embodiment is believed at the time of the filing of this patent application to possibly reside broadly in a method of installing at least one sensor in a luminaire, wherein the step of electrically connecting the at least one sensor with the luminaire comprises tool-lessly electrically connecting the at least one sensor with the luminaire.

Yet an additional feature or aspect of an embodiment is believed at the time of the filing of this patent application to possibly reside broadly in a method of installing at least one sensor in a luminaire, wherein the step of electrically connecting the at least one sensor with the luminaire comprises plugging in a first plug for energizing the array of LEDs and plugging in a second plug for electrically cooperating the sensor with the array of LEDs.

Nomenclature

| | |
|---|---|
| LED luminaire | 100 |
| Lighting panel | 102 |
| opening in lighting panel | 103 |
| locking ring | 104 |
| side wall of lock | 105 |
| sensor housing | 106 |
| upper wall of lock | 107 |
| driver cover | 108 |
| sensor housing side wall | 109 |
| mount | 110 |
| lock | 111 |
| inner side wall of luminaire | 112 |
| luminaire housing | 113 |
| protuberance | 114 |
| gripping surface | 115 |
| inner trim ring | 116 |
| fasteners | 117 |
| receiver | 118 |
| fasteners | 119 |
| ridge | 120 |
| fasteners | 121 |
| stop | 122 |
| fastener receptacle | 124 |
| fastener receptacles | 125 |
| fastenter receiver | 126 |
| recess | 127 |
| sensor housing bottom wall | 128 |
| electrical line | 130 |
| electrical plug or receptacle | 131 |
| flange | 134 |
| inner wall | 136 |
| cover | 140 |
| extension | 142 |
| opening | 144 |
| outer trim ring | 146 |
| lens | 148 |
| outer gasket | 150 |
| inner gasket | 151 |
| LED board | 152 |
| fins | 154 |
| apertures | 155 |
| fasteners | 156 |
| electrical connector | 160 |
| body | 162 |
| cable 1 | 164 |
| cable 2 | 168 |
| cable 3 | 170 |
| cable 4 | 172 |
| node | 171 |

1. An LED luminaire comprising:
a lighting panel having an array of LEDs;
a centrally oriented opening in the lighting panel; and
wherein the LED luminaire is configured for the installation of at least one sensor in the centrally oriented opening in the lighting panel.

2. The LED luminaire of claim 1 further comprising a sensor housing configured to be installed in the centrally oriented opening in the lighting panel, the sensor housing holds the at least one sensor.

3. The LED luminaire of claim 2, wherein the at least one sensor is configured to switch the array of LEDs on and off.

4. The LED luminaire of claim 2, wherein the sensor housing is configured to be tool-lessly installed in the centrally oriented opening in the lighting panel.

5. The LED luminaire of claim 2, wherein the at least one sensor has at least one of a motion sensor and a light sensor.

6. The LED luminaire of claim 1, wherein the lighting panel is circular.

7. The LED luminaire of claim 1, wherein the centrally oriented opening in the lighting panel and the sensor housing are circular.

8. The LED luminaire of claim 7, wherein the sensor housing is configured to be rotated and removably locked into the centrally oriented opening in the lighting panel.

9. The LED luminaire of claim 8, wherein the sensor housing comprises a locking ring configured to cooperate with a protuberance extending into the centrally oriented opening in the lighting panel.

10. The LED luminaire of claim 1, wherein the sensor housing has a hand gripping surface, configuring the sensor housing to be rotated by hand and to be tool-lessly installed in the LED luminaire.

11. The LED luminaire of claim 3 further comprising an electrical connector, the electrical connector having a first cable configured to be electrically connected with electrical lead lines external of the luminaire, a second cable configured to be electrically connected with the lighting panel or a driver, and a third cable configured to be electrically connected with the at least one sensor.

12. The LED luminaire of claim 11, wherein the second cable and the third cable each terminate with plug.

13. The LED luminaire of claim 11, wherein the electrical connector further comprises a fourth cable configured for dimming the array of LEDs.

14. An electrical connector comprising a first cable configured to be electrically connected with electrical lead lines, a second cable configured to be electrically connected with a lighting panel or driver, and a third cable configured to be electrically connected with a sensor, wherein the electrical connector is configured to electrically communicate the sensor with the lighting panel or driver.

15. A method of tool-lessly installing at least one sensor in a luminaire comprising the steps of:
providing a luminaire having a lighting panel with an array of LEDs disposed about a centrally oriented opening in the lighting panel;
providing a sensor housing having the at least one sensor therein;
electrically connecting the at least one sensor with the luminaire;
inserting the sensor housing into the centrally oriented opening; and
removably locking the sensor housing in the centrally oriented opening in the lighting panel.

16. The method of installing at least one sensor in a luminaire of claim 15, wherein the step of removably locking the sensor housing in the centrally oriented opening in the lighting panel comprises hand rotating the sensor housing in the centrally oriented opening.

17. The method of installing at least one sensor in a luminaire of claim 16, wherein the step of rotating the sensor housing in the centrally oriented opening comprises cooperating an upper wall of a lock on the sensor housing with a protuberance in the centrally oriented opening, thereby holding the at least one sensor in the luminaire.

18. The method of installing at least one sensor in a luminaire of claim 17, wherein the step rotating the sensor housing in the centrally oriented circular opening comprises cooperating a bump out extending outward from a sidewall of the lock with the protuberance, thereby removably locking the sensor housing in the luminaire.

19. The method of installing at least one sensor in a luminaire of claim 15, wherein the step of electrically connecting the at least one sensor with the luminaire comprises tool-lessly electrically connecting the at least one sensor with the luminaire.

20. The method of installing at least one sensor in a luminaire of claim 19, wherein the step of electrically connecting the at least one sensor with the luminaire comprises plugging in a first plug for energizing the array of LEDs and plugging in a second plug for electrically cooperating the sensor with the array of LEDs.
